(19) United States
(12) Patent Application Publication
(10) Pub. No.: US 2019/0359804 A1
(43) Pub. Date: Nov. 28, 2019

(54) TEXTURED POLYMER COMPOSITIONS

(71) Applicant: SABIC GLOBAL TECHNOLOGIES B.V., BERGEN OP ZOOM (NL)

(72) Inventors: Maria Soliman, Geleen (NL); Maurice Nicolaas Maria Dohmen, Geleen (NL)

(21) Appl. No.: 16/477,394

(22) PCT Filed: Jan. 24, 2018
(86) PCT No.: PCT/EP2018/051656

§ 371 Date: Jul. 11, 2019

Related U.S. Application Data
(60) Provisional application No. 62/449,925, filed on Jan. 24, 2017.

(30) Foreign Application Priority Data
Apr. 6, 2017 (EP) 17165248.0

(51) Int. Cl. C08L 23/06; C08J 7/04; B29C 48/00

(52) U.S. Cl. CPC C08L 23/06; C08J 7/04; B29C 48/022; C08L 2205/025; C08L 2207/062; B29K 2023/065; C08L 2203/18; C08J 2323/06; C08J 2423/06; C08J 2423/12; C08L 2207/066

(57) ABSTRACT

The present invention relates to an article comprising a textured polymer surface for receiving a liquid, wherein the textured surface has an average surface roughness (Ra) in the range between 5 to 100 μm.

The present invention relates to textured polymer compositions.

Polymer-based articles are commonplace in current commercial applications. Such articles include containers for various materials, pipes for transporting materials and other surfaces that may come into contact with such materials. Therefore, it is oftentimes important that the surface or surfaces in contact with the materials demonstrate low levels of drag or friction. To accomplish these results, the articles often comprise multi-layer systems that include a polymer base layer, a drag reducing material, and generally an intermediate layer to retain the drag reducing material to the polymer base layer. There remains a need for additional polymer constructions or surfaces with improved properties or methods of manufacture that can be used to improve consumer goods etc.

It is one object of the present invention to provide a polymer having a textured surface for receiving and retaining liquids having drag or friction reducing properties, the liquid forming a coating or thin film over the surface. The textured surface of a polymer can enhance the interaction between the polymer surface and a liquid facilitating formation of a liquid coated textured polymer. Such polymers can be used to manufacture various article having a coated textured polymer surface.

Certain embodiments described herein are directed to a polymer having at least one textured surface that is configured to receive and interact with a coating. In certain aspects the coating is a liquid coating. In a further aspect the polymer has a surface texture that enhances the interaction between a coating and the surface resulting in the coating being retained on the polymer surface forming a thin film. The liquid maybe retained on the textured surface of the polymer more than 15% longer compared to pure HDPE. The retaining properties may be determined by wetting studies. Thereby the flow time and behavior of a droplet of the liquid that moves from point A to point B under an angle of 33° is determined.

In certain instances the coated textured polymer can be included in an article of manufacture (article) that includes such a surface. An article as described herein comprises a polymer with a textured surface that can receive and retain a liquid at the surface of the polymer. In a further aspect a coated textured polymer surface specifically excludes a primer or an intermediate layer between the liquid and the surface of the polymer. In certain aspects the textured polymer surface can comprise peaks and valleys, and/or pores or cavities distributed across the surface. In certain embodiments the article, having a coated textured polymer surface demonstrates a reduced viscous drag between the article and a moving semi-solid, liquid, gel, or paste that is contact with the article.

A surface can be designed to have a three dimensional structure or roughness (i.e., surface texture). The textured surface can include projections formed of or by a roughening agent. The roughening agent can include, but is not limited to mica, talc, or silica. In certain aspects the projections have an irregular shape. In further aspects the textured surface has an average surface roughness (Ra) in the micron range (1 to 100 μm). In particular aspects the Ra is between about 1 to 90 μm, about 1 to 50 μm, about 1 to 25 μm, or about 1 to 10 μm. The textured surface can be defined by the average height (H) of surface projections, average width of surface projections (W), peak to peak distance (L), radius of curvature of surface projections (R), pore diameter (D), and/or pore depth (pD). The projections can have an average height of between about 0.5 and 125 μm, about 0.5 to 75 μm, or about 0.5 to 25 μm. The projections can have an average width of about 5 to 650 μm, about 5 to 500 μm, about 5 to 250 μm, or about 5 to 125 μm. The textured surface can have pores with an average pore depth of about 1 to 125 pm, about 1 to 100 μm, or about 1 to 75 μm; and an average pore diameter of about 1 to 20 μm, about 1 to 15 μm, or about 1 to 10 μm. The projections or pores can be present with an average spacing of about 0.1 to 500 μm, about 0.1 to 250 μm, or about 0.1 to 125 μm between projections or pores. In certain aspects the textured surface receives, or can be coated or contacted with a liquid, forming a coated article having a thin liquid film at the surface. A liquid can fill the spaces in the textured surface and form a thin film over the surface forming a coated article.

In certain aspects a textured polymer as described herein can comprise (i) a polymer, co-polymer, or polymer mixture, (ii) an additive(s) that provides directly or indirectly for a surface texture, and (iii) optional components.

The polymer can comprise at least one thermoplastic or a blend of two or more thermoplastics. The at least one thermoplastic or blend of two or more thermoplastic can be selected from, but not limited to high density polyethylene (HDPE), linear low density polyethylene (LLDPE), low density polyethylene (LDPE), polypropylene (PP), polyolefin elastomer (POE), polyethylene terephthalate (PET), polyesters (e.g., polylactic acid (PLA)), polyvinyl chlorides, styrenes (e.g., polystyrenes (PS)), polyamides, polycarbonates, or other suitable thermoplastics. In certain aspects the polymer comprises HDPE. A first polymer can be present in the polymer composition at an amount of about 50 to 99.9, about 50 to about 95, about 50 to 90, about 50 to 85, about 50 to 80, about 50 to 75, about 60 to 99.9, about 60 to about 95, about 60 to 90, about 60 to 85, about 60 to 80, about 60 to 75, about 70 to 99.9, about 70 to about 95, about 70 to 90, about 70 to 85, about 70 to 80, about 70 to 75, about 80 to 99.9, about 80 to about 95, about 80 to 90, about 80 to 85 total weight percent (wt %) of the polymer composition. The polymer composition can include one or more additives that directly or indirectly provide texture to the surface of a polymer. In certain aspects a second or additional polymer or polymer mixture can be included that directly or indirectly produces a textured surface, particularly when mixed with HDPE, such a polymer can be considered an additive and is referred to herein as a “second polymer.” A second polymer can be present in the polymer composition at an amount of about 5, 10, 15, 20, 25, to 30 total weight percent. In certain aspects the polymer can include 5 to 30 wt % of a second polymer and 0.1 to 20 wt % of a roughening agent. In certain aspects the second polymer selected from polypropylene (PP), linear low density polyethylene (LLDPE), low density polyethylene (LDPE), polyolefin elastomer (POE) or combinations thereof.

In certain aspects a polymer composition comprises (i) about 90 to 95 wt % of HDPE and about 5 to 10 wt % of polyolefin elastomers (POE); (ii) about 85 to 90 wt % of HDPE and about 10 to 15 wt % of POE; (iii) about 90 to 95 wt % of HDPE and about 5 to 10 wt % of LDPE; (iv) about 85 to 90 wt % of HDPE and about 10 to 15 wt % of LDPE; (v) about 30 to 40 (e.g., 38) wt % of HDPE having a density of about 950 kg/m3 and about 60 to 70 (e.g., 62) wt % of HDPE having a density of about 960 kg/m³; (vi) about 40 to 60 (e.g., 63) wt % of HDPE, about 5 to 20 (e.g., 10) wt % of POE, and about 20 to 30 (e.g., 27) wt % polypropylene (PP); (vii) about 90 to 95 wt % of HDPE and about 5 to 10 wt % of mica; (viii) about 90 to 95 wt % of HDPE and about 5 to 10 wt % talcum; (ix) about 80 to 90 wt % of HDPE and about 10 to 20 wt % of talcum; or (x) about 95 to 99.8 wt % of HDPE and about 0.2 to 5 wt % silica. Density is measured according to ISO 1183.

As used herein, providing texture “directly” refers to the additive being present in the extrusion, molding, or blow molding of an article forming the texture elements, e.g., surface projections. Providing texture “indirectly” refers to an additive that is modified, evaporated, dissolved, degraded, or otherwise removed from the polymer composition to form a texture element, e.g., pore or a cavity. The additive or a combination of additives can be present in an amount of about 0.1 to 50, about 0.1 to 20, or about 0.1 to 10 total weight percent (wt %) of the polymer composition. The polymer composition can be further processed to form a polymer product that comprises at least one textured surface for receiving a liquid. The weight percent of the additive(s) refers to the weight percent before an additive(s) is modified, evaporated, dissolved, degraded, or otherwise removed from the polymer composition to form a texture element, noting that some additive remain intact and form part of the polymer product.

Additional components can be included in the polymer composition and the weight percent adjusted accordingly. Examples of additional components are stabilizers, antioxidants, lubricants, fillers, dyes, pigments, flame retardants, and reinforcing fibers. The additional components can be included in varying amounts. In certain aspects the additional components can be present in a total wt % of about 0.1 to 20 wt %.

Certain embodiments are directed to an article of manufacture comprising a textured polymer surface for receiving a liquid. In certain aspects the article is a tube, pipe, vessel, bottle, container, or jar manufactured from a polymer composition described herein. In a further aspect the article is configured to contain or transport a liquid, gel, paste, or semi-solid material.

Other embodiments are directed to methods for producing a container. The methods can include: (a) blow molding a container having a textured surface as described herein, the surface can be an inner surface, outer surface, or an inner and outer surface; and (b) coating or contacting the textured surface with an liquid forming a polymer/liquid composite. In certain instance the liquid will form a thin film over the textured surface of the container resulting in the composite. Suitable processing techniques for producing shaped articles of the polymer according to the invention include extrusion (e.g., film or tube extrusion), injection molding, compression molding, blow molding, or other processing techniques.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

The following drawings form part of the present specification and are included to further demonstrate certain aspects of the present invention. The invention may be better understood by reference to one or more of these drawings in combination with the detailed description of the specification embodiments presented herein.

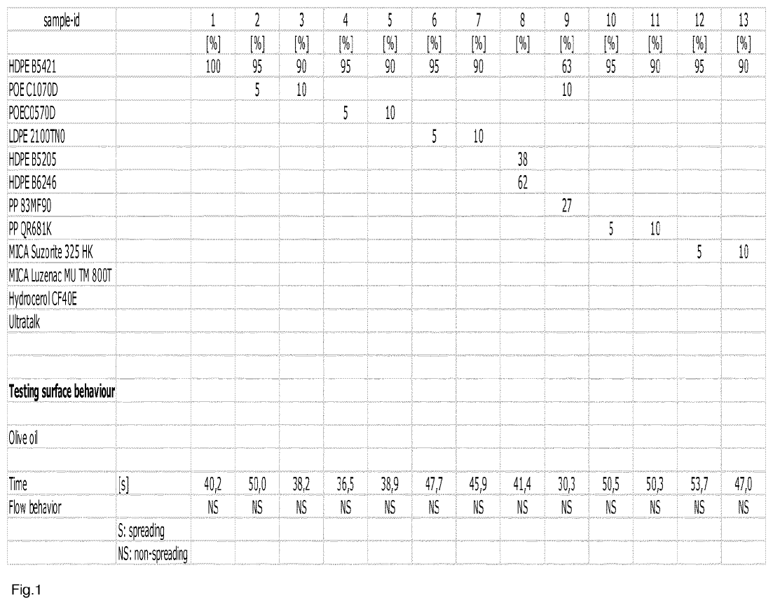

FIG. 1. An example of olive oil wetting behavior on the surface of selected textured polymers showing time and flow behavior (S=spreading and NS=non-spreading).

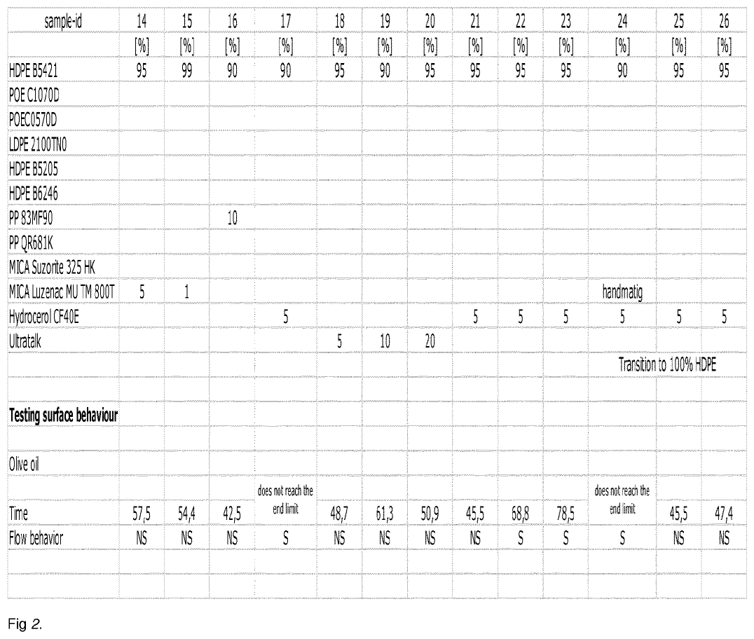

FIG. 2 A second example of olive oil wetting behavior on the surface of selected materials showing time and flow behavior (S=spreading and NS=non-spreading).

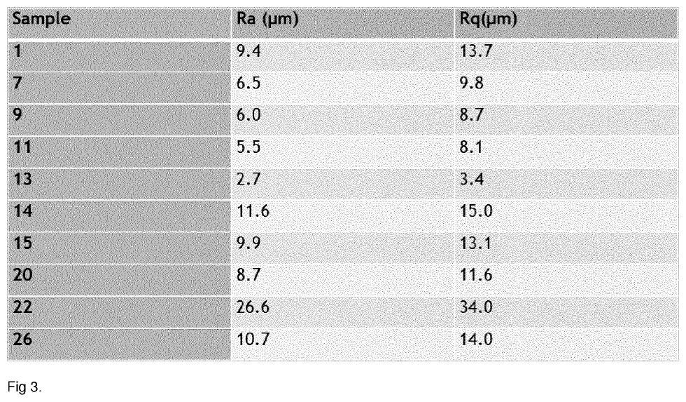

FIG. 3 A table illustrating laser profilometer roughness measurements of selected surfaces. Ra is the mean roughness or roughness average and Rq is the root mean square roughness.

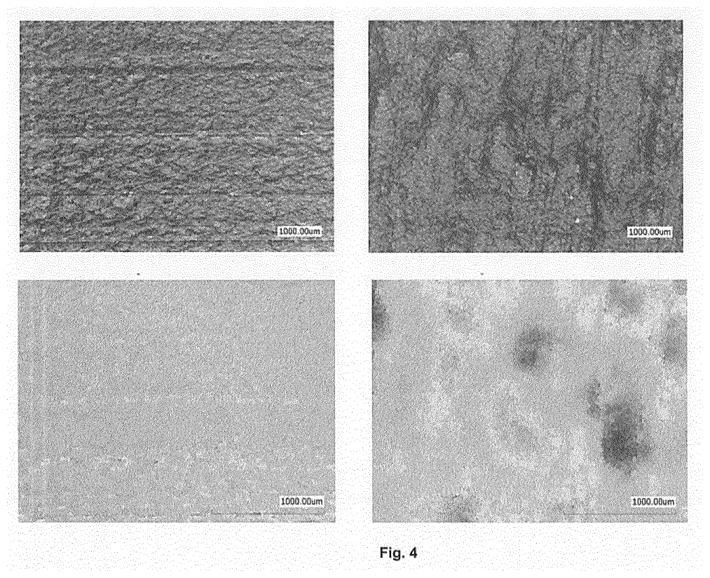

FIG. 4 An example of a visualization of a surface measured using a laser profilometer. Right images being HDPE and Left images being HDPE+5% hydrocerol, which forms a foam or porous structure.

Certain embodiments are directed to polymer articles having at least one textured surface for receiving a liquid coating, the coated surface having lower drag or reduced friction. The textured polymer surface provides for retention of a liquid forming a thin film on the surface of the textured polymer (coating the surface). The textured polymer surfaces described herein are less expensive and easier to fabricate. In certain aspects the surface texture can be characterized using commercially available surface texture measurement devices, such as profilometers and the like.

The properties of the textured polymer surface can be designed based on the composition of the polymer, surface texture parameters, and/or character of the liquid coating. In certain aspects the polymer includes at least first polymer, such as HDPE. In other aspects the polymer is HDPE, LDPE, LLDPE, PP, POE, or a mixture thereof. In a further aspect a second polymer is selected as an additive, the second polymer or additive polymer can be selected from, but not limited to LDPE, LLDPE, PP, POE, or a mixture thereof. In certain aspects the second polymer is selected for properties that result in a textured polymer surface upon processing, for instance a foaming reaction. Articles of the invention have at least one textured polymeric surface that can be coated or contacted with a liquid that adheres to the textured surface.

As used herein the polymers include, but are not limited to:

HDPE is a polyethylene with a density (p) of at least (≥) 940 kilograms per cubic meter (kg/m³).

LDPE is a polyethylene having a density of from about 910 to about 940 kg/m³ produced using radicals, for instance from oxygen or peroxide catalysts, at high pressure.

LLDPE (as distinguished from LDPE) is a homopolymer or copolymer of ethylene and with at least one α-olefin containing from 3 to 20 carbon atoms (C₃₋₂₀), made using transition metal catalysts and having a density from 915 to 930 kg/m³. Suitable α-olefins are aliphatic α-olefins containing from 3 to 20, preferably from 3 to 12, more preferably from 3 to 8 carbon atoms (C₃₋₂₀, C₃₋₁₂, C₃₋₈). As used herein, subscripts indicate the number of, for example carbon (C) atoms contained in a monomer. Particularly suitable alpha-olefins include ethylene, propylene, butene-1, 4-methyl-1-pentene, hexene-1 or octene-1, or ethylene in combination with one or more of propylene, butene-1,4-methyl-1-pentene, hexene-1 and octene-1. Where LDPE has long chain branches as a result of the radical polymerization, the LLDPE is linear except for short chain branches that come from the co-monomers.

Polypropylene (PP) materials include (a) propylene homopolymers, (b) random and block copolymers of propylene and an olefin selected from ethylene, 1-olefins (α-olefins) containing 4 to 10 carbon atoms (C₄₋₁₀) and C₄₋₁₀ dienes, and (c) random terpolymers of propylene and two monomers selected from ethylene and C₄₋₁₀ α-olefins. The C₄₋₁₀ α-olefins may be linear or branched, but are preferably linear.

α-olefins are acyclic alkenes having a double bond connecting the first and the second carbon atom in the carbon chain. Examples of α-olefins are ethylene, propylene, 1-butene, 1-methyl-4-pentene, 1-hexene, and 1-octene.

Polyolefin elastomers (POEs) are copolymers of ethylene and another alpha-olefin such as butene or octene. POEs have both thermoplastic and elastomeric properties, which can be processed by common processing methods for thermoplastic materials and have a density of less than 900 kg/m³.

A polymer surface can be textured by providing reaction materials, processing conditions, or post-polymerization treatments to form a surface texture comprising (a) projections, (b) open pores, or (c) projections and open pores. The polymerization reactions can be performed at a temperature of 5 to 100° C., including all values and ranges there between. Furthermore the polymerization reactions can be performed at a pressure of 0.1 to 10 MPa, including all values and ranges there between.

In one aspect, the invention is directed to an article comprising a liquid coated polymer surface, the polymer surface having a texture or roughness for receiving and retaining a liquid. The liquid can be retained between surface features, within surface features, or between and within surface features. The texture of the surface is such that the liquid is contained or maintained in or on the surface independent of the orientation of the surface (0 to 360 degrees relative to horizontal).

In certain aspects the surface texture is at least in part provided by additives (roughening agents). In certain aspects the additive(s) are incorporated in the polymer forming projections or pores/cavities in a polymer surface. A roughening agent imparts a roughness to the surface by providing a material that causes protrusions from the surface forming peaks and valleys. Other roughening agents are agents can be foamed, removed, modified, or partially removed during or after processing to form projections and/or pores in or on the surface of the polymer. The amount of surface texture is controlled by the amount of additive in, on, or in and on the polymer support during the manufacturing process. The amount of additive included in the polymer support can depend on the properties needed for a certain target in any given application.

In certain aspects, the target can be a substance to be contained or transported within or placed in contact with a container (e.g., a bottle or jar) or a conveyance device (e.g., pipeline) that has a surface that is a coated textured polymer surface as described herein. The amount and type of additive should be selected to provide a surface texture that yields the appropriate surface with its attendant properties.

The additive can be present in an amount of about 0.1 to 50 wt %, 0.1 to 20 wt %, 0.1 to 10 wt % of the polymer composition. Depending on various factors, such as the desired surface texture, the additive material can be present in an amount between about 5 to 20 wt % of the polymer composition. The additive can form projections and/or pores having variety of shapes, that include, but are not limited to rounded, columnar, pyramidal, and/or random geometry (irregular) protrusions, and/or pores (e.g., cavities) that provide a surface texture. The spacing of projections or pores can be determined by measuring the shortest distance between two adjacent projections or the edges of adjacent pores. The projections or pores can be dispersed on the surface forming an average spacing between projections and/or pores of about 0.01 to 500 microns, including all values and ranges there between. In a further aspect the projections can have an average height of about 1 to 125 microns relative the plane of the surface. In certain aspect the pores can have an average depth of about 1 to 125 microns relative the plane of the surface.

In certain embodiments the additive is a roughening agent. The roughing agent is preferably an inorganic material. In certain aspects the roughening agent is melt compoundable with a selected polymer. The roughing agent can include inorganic materials, alone or in combination. For example zeolites, glass, talc, mica, clay, silica, sodium, calcium, alumino silicates, calcium carbonates, aluminum silicates, sodium silicates, magnesium silicates, calcium silicates, and silicon dioxides. In certain aspects mica, talc, clay, or silica is used as the roughening agent. The roughening agent can be a regular or irregular particle having an average dimension that can be the diameter for approximately spherical particles or length for approximately rod-shaped particles. For irregular particles the average dimension can be the largest dimension presented by an irregular shape. In certain aspects the roughening agent is in particle form. In a further aspect the particles have an average dimension of about 5 to 640 0.1 to 500 microns, including all values and ranges there between.

In certain aspects a textured polymer surface can have a plurality of pores, cavities, interconnected pores, and/or interconnected cavities. The plurality of pores, cavities, interconnected pores, and/or interconnected cavities can be formed by using a conditioning agent as an additive. A conditioning agent is used to form the texture on the surface, but is not necessarily present in the final textured product. For example, a conditioning agent can be used to form pores or wells that can be filled by a liquid, the pores can formed by embedding salts or other dissolvable or degradable materials in the polymer or polymer surface and removing the materials during or after polymerization. The conditioning agent can be removed by using a solvent, heat, or electromagnetic radiation to dissolve or degrade the conditioning agent or a portion of the polymer that was in contact with the conditioning agent or not in contact with the conditioning agent. Another example of a conditioning agent is a second polymer that is immiscible with first polymer that is used as the base material. In certain aspects the immiscible second polymer forms pores or cavities in the polymer surface during processing. In certain embodiments the pores or cavities have average relief depths of about 1 to 20 μm, surface cavity diameters from about 1 to 10 μm, and/or porosity densities in the range of about 4 to 120 pores per μm².

In another embodiment the pores or cavities can be formed by foaming or pitting the surface of polymer base or support. The surface of the polymer base or support can be foamed using physical, chemical, or physical and chemical methods. Physical foaming agents include but are not limited to organic materials as hydrocarbons or chlorinated hydrocarbons, or inorganic materials as nitrogen or carbon dioxide or combinations of both. Chemical foaming agents can be of the exothermic or endothermic types, such as carbon dioxide with an endothermic chemical blowing agent. Physical pitting processes include sand blasting. In certain aspects the foaming process is performed at about 40 to 260° C. The foaming procedure can form the pores or cavities as described above. In certain embodiment the foam has an open cell structure, limited cell size, and limited thickness in relation to the open cell structure. Polymers with a low melt strength behavior are suitable to produce open cell structures, e.g. high MFI HDPE; PP; or LL/MDPE.

The surface texture provides a geometry that provides for interaction with a liquid that can fill the space between or in the textural features and coat the surface with a layer (thin film) of liquid of about 1 to 5 nm in thickness above the plane of the polymer surface. In certain embodiments, the liquid has a receding contact angle of 0° such that the liquid forms a stable thin film on the surface.

The liquid can be introduced to the textured polymer surface using conventional techniques for applying a liquid to a solid. In certain embodiments, a coating process, such as a dip coating, blade coating, or roller coating, is used to apply a liquid. After the liquid has been applied, capillary forces hold the liquid in place. Capillary forces scale roughly with the inverse of feature-to-feature distance or pore radius, and the features may be designed such that the liquid is held in place despite movement of the surface and despite movement of air or other fluids over the surface. In certain aspects, the liquid has a viscosity at room temperature of at least, at most, or about 50 to 5000 cP (or cSt). In certain embodiments, the liquid can be any type of liquid that is capable of providing the desired properties. For example, the liquid can be an oil-based or water-based liquid. In certain aspects, the liquid is an ionic liquid. Other liquids include hexadecane, vacuum pump oils, silicone oils, fluorocarbons, liquid polymers, dissolved polymers, and viscoelastic fluids. In certain embodiments, the liquid includes a liquid metal, a dielectric fluid, a ferro fluid, a magneto-rheological (MR) fluid, an electro-rheological (ER) fluid, an ionic fluid, a hydrocarbon liquid, and/or a fluorocarbon liquid.

Certain embodiments are directed to articles of manufacture having a wall or a surface that is a textured polymer for receiving a coating. In one aspect the wall or support is monolithic or a single layer having a textured surface. In other aspects the surface is an inner surface of a pipe, tube, syringe, bottle, jar, or other container or fluid transfer device. An article comprising a textured polymer surface includes a textured polymer surface coated with a liquid, wherein the liquid forms a thin film, i.e., a coated textured polymer surface. The thin film modulates interaction between the polymer article and a target fluid or material. In certain aspects the target material is a liquid, lotion, gel, paste, or the like. In certain aspects the target material is a foodstuff (e.g., condiment, jelly, or the like) or a cosmetic (e.g., a shampoo or other cosmetic liquid or gel).

In certain aspects a polymer composition described herein can have sufficient environmental stress crack resistance (ESCR). ESCR testing can be performed using, for example, ASTM D1693, condition B, with 10% igepal. In some aspects, the polymers described herein can have an ESCR (using 10% igepal) of greater than or equal to about 600 to 2500 hours. The ESCR test is typically stopped after a certain number of hours is reached, and given the long duration of the test, the upper limit of ESCR (in hours) is generally not determined.

A coated textured polymer surface can be used to reduce viscous drag between a solid surface and a flowing target. In general, the viscous drag or shear stress exerted by a target liquid flowing over a solid surface is proportional to the viscosity of the target liquid and the shear rate adjacent to the surface.

The polymer having a textured surface for receiving a liquid can be used in producing an article of manufacture that includes a coated inner textured polymer surface of the current invention. An article of the current invention can be produced by various processes used in thermoplastics manufacture, including blow molding. Blow molding is a manufacturing process by which hollow plastic parts are formed. In general, there are three main types of blow molding: extrusion blow molding, injection blow molding, and injection stretch blow molding. The blow molding process begins with melting down the plastic and forming it into a parison or in the case of injection and injection stretch blow molding (ISB) a preform. The parison is a tube-like piece of plastic with a hole in one end through which compressed air can pass. The parison is then clamped into a mold and air is blown into it. The air pressure then pushes the plastic out to match the mold. Once the plastic has cooled and hardened the mold opens up and the part is ejected. In certain embodiments of the current invention at least one surface of the part is coated with a liquid or is further process and then coated with a liquid to form a coated textured polymer surface.

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

### Production and Testing of Materials

Test films were or can be prepared by using a micro compounding line with a cast film die to prepare cast film. Approximately 10 gram of polymer were used to produce 5 meter cast film. A melt web is cooled by an air knife (a simulation of blow molding process by blowing air to the melt).

In an alternative method, micro blown film lines were produced using approximately 1 kg of sample. A micro blown film line was used with a low BUR (1.5 to 2) to produce a pipe shape product with a thickness of a least 200 μm. Another option is to connect a cast film die to the compounder to produce cast film having a thickness target of 300 μm. In these processes a melt web is cooled by an air knife.

Production tests are designed and performed. Various compounds were tested in a primary texture screen. After selection, the selected polymer formulations are further screened for functional properties. In one aspect the selected polymer formulation can be tested using a blow molding line to produce small bottles.

The surface roughness of the test materials can be measured by a laser profilometer to create 3D pictures. In certain aspects the laser profile meter can be set to at least 0.5 μm.

In certain instances the smallest bottle produced is about 110 ml, using 5.5 kg/hour mono-layer with 20 g at 14 sec cycle time. An additional amount of resin (15-20 kg) may be needed for purging to get a clean layer.

Processing of tapes can be performed, for example, with the following setup:

(i) 11 mm twin screw extruder with a L/D of 40; (ii) volumetric feeders to add base material and the additives, (iii) cast film die with adjustable slit, (iv) air knife to cooldown the extruded melt by blowing air to the melt, (v) chill roll with air pipe for additional cooling of the melt, (vi) nipp rolls module to setup the thickness of the tape, and (vii) winding module to wind up the produced tape.

### EXAMPLE 2

### Olive Oil Wetting Behavior

The purpose of the olive oil wetting studies is to determine the flow time and behavior of a droplet of olive oil that moves from point A to point B under an angle of 33°. The flow time and behavior of the droplet (spreading or non-spreading) was determined. An increasing surface roughness should result in an increase in the flow time and the oil will spread over the surface.

A sample is fixed with double sided tape to a flat surface. Using a dispenser, a droplet of olive oil is placed on the surface. A video camera registers the flow behavior and movement of the droplet. Results from a number of these studies are presented in FIG. 1 and FIG. 2. Eighty percent of the tested samples have a higher flow time when compared to a reference HDPE. The flow time of samples containing fillers (mica/talcum) or cell structures (foam) are significantly higher than virgin samples. Samples with cell structures produce a surface with the highest flow time, but also absorb the oil (its spreading out in the surface). Compounds of HDPE with other type of polymers, such as HDPE of varying density, PP, and POE produce a surface that decreases the roughness because the flow time is faster compared to the reference HDPE. Roughness measures are provided in FIG. 3. An example of a visualization of the roughness measurement is provided in FIG. 4.

1. An article of manufacture comprising a polymer/liquid composite, the polymer comprising a high density polyethylene (HDPE) polymer and
(i) a roughening agent selected from mica, talcum, or silica, and/or
(ii) a second polymer selected from polypropylene (PP), linear low density polyethylene (LLDPE), low density polyethylene (LDPE), polyolefin elastomer (POE), a second high density polyethylene (HDPE) or combination thereof,
the polymer having a textured surface, wherein the textured surface has an average surface roughness (Ra) in the range between 5 to 100 μm; and
a liquid having drag reducing properties that is retained on the textured surface of the polymer forming a polymer/liquid composite.

2. The article according to claim 1, wherein the surface has projections with a height of 1 to 125 μm and a base width of 5 to 640 μm with a spacing of 0.1 to 500 μm between projections.

3. The article according to claim 1, wherein the textured polymer comprises 80 to 99.9 weight percent of a HDPE polymer and/or 0.1 to 20 weight percent of a roughening agent.

4. The article according to claim 1, wherein the polymer comprises 0.1 to 10 weight percent mica.

5. The article according to claim 1, wherein the polymer comprises 0.1 to 10 weight percent silica.

6. The article according to claim 1, wherein the polymer comprises 0.1 to 20 weight percent talcum.

7. The article according to claim 1, wherein the polymer comprises 50 to 95 weight percent HDPE and 5 to 30 weight percent of the second polymer, and/or 0 to 2 weight percent of an additive.

8. The article according to claim 1, wherein the liquid is retained on the textured surface of the polymer more than 15% longer compared to pure HDPE.

9. The article according to claim 1, wherein the article is a container, tube, or pipe.

10. A method for producing an article of manufacture according to claim 1, comprising a textured polymer surface for receiving a liquid, the method comprising processing a polymer composition to form a textured polymer surface by (a) extruding or molding a polymer composition comprising a high density polyethylene (HDPE) and roughening agent selected from mica, talc, or silica to form an article having a textured polymer surface, the textured polymer surface having an average surface roughness (Ra) in the micron range and capable of receiving and retaining a liquid coating.

11. The method according to claim 10, further comprising coating the textured polymer surface with a liquid forming a coated textured polymer surface.

12. The method according to claim 10, wherein the resulting textured polymer surface has projections with a height of 1 to 125 μm and a base width of 5 to 640 μm, with a spacing of 0.1 to 500 μm between projections or pores.

13. The method according to claim 10, further comprising inserting into the article a liquid, gel, paste, or semi-solid material.

14. The method according to claim 13 wherein the liquid, gel, paste, or semi-solid material which is inserted, is retained on the textured surface of the polymer more than 15% longer compared to pure HDPE.

15. The method according to claim 10, where in article contains a shampoo or cosmetic.

16. The article according to claim 1,
wherein the surface has projections with a height of 1 to 125 μm and a base width of 5 to 640 μm with a spacing of 0.1 to 500 μm between projections;
wherein the textured polymer comprises 80 to 99.9 weight percent of a HDPE polymer and/or 0.1 to 20 weight percent of a roughening agent;

17. The article according to claim 16, wherein the polymer comprises 50 to 95 weight percent HDPE and 5 to 30 weight percent of the second polymer, and/or 0 to 2 weight percent of an additive.

18. The article according to claim 1,
wherein the surface has projections with a height of 1 to 125 μm and a base width of 5 to 640 μm with a spacing of 0.1 to 500 μm between projections;
wherein the polymer comprises 0.1 to 10 weight percent mica, or 0.1 to 10 weight percent silica, or 0.1 to 20 weight percent talcum;

19. The article according to claim 18, wherein the polymer comprises 50 to 95 weight percent HDPE and 5 to 30 weight percent of the second polymer, and 0 to 2 weight percent of an additive.
